(19) United States
(12) Patent Application Publication
(10) Pub. No.: US 2026/0134786 A1
(43) Pub. Date: May 14, 2026

(54) Remote Control Of Three-Dimensional Object Projection In A Networked Learning Environment

(71) Applicant: Saras-3D, Inc., Allentown, PA (US)

(72) Inventors: Bipin D. Dama, Bridgewater, NJ (US); Kalpendu Shastri, Orefield, PA (US); Soham Pathak, Allentown, PA (US); Terry Ki Lim, Emmaus, PA (US); Ankita Shastri, Marysville, WA (US)

(73) Assignee: Saras-3D, Inc., Allentown, PA (US)

(21) Appl. No.: 18/706,167

(22) PCT Filed: Nov. 1, 2022
(86) PCT No.: PCT/US2022/048510

§ 371 Date: Apr. 30, 2024

Related U.S. Application Data
(60) Provisional application No. 63/275,031, filed on Nov. 3, 2021.

(51) Int. Cl. G09B 5/14; G06F 3/04815; G09B 5/06

(52) U.S. Cl. CPC G09B 5/14; G09B 5/06; G06F 3/04815

(57) ABSTRACT

A teacher-controlled learning environment is disclosed that allows for remotely-located students to view 3D manipulation of objects associated with a lesson. Teacher-controlled viewing of 3D content (particularly relevant for STEM applications) is enabled across multiple devices that are networked via a specific platform, allowing for remote manipulation of 3D objects (as controlled by the teacher/host), where the student wears stereoscopic 3D glasses and the teacher's remote software “takes over” the student's device to provide the actual 3D object manipulation.

### CROSS-REFERENCE TO RELATED APPLICATIONS

This application claims the benefit of U.S. Provisional Application No. 63/275,031, filed on Nov. 3, 2021 and herein incorporated by reference.

### TECHNICAL FIELD

This invention relates to education technology and enables creative digital content sharing among educators and students.

### BACKGROUND OF THE INVENTION

Various prior art educational platforms exist for use in the virtual learning environment. One prior art platform provides a “seamless” platform that utilizes both “live” lectures (such as via Zoom, YouTube, or the like) in combination with pre-recorded lectures. In addition, it provides features and tools that are useful to a teacher (such as remote questioning of students, giving tests, and the like). Another platform is known to provide live tutoring over Zoom between people anywhere in the world.

Beyond these available platforms, the need for excellence in a “distance learning” mode has become quite evident during the recent months of pandemic isolation. One such distance learning methodology is based on self-directed instruction initiated by a student without “live” teacher involvement and includes the use of three-dimensional (3D) models of various objects (variously referred to as “manipulatives” in academic parlance) that are observable by a student wearing 3D stereoscopic glasses (or similar technology). In this distance learning environment, a student is able to control the movement of a three-dimensional object (for example, a model of an atom) to supplement the learning gained via other two-dimensional sources (e.g., text books, teacher lectures, videos, and the like).

The ability for a student to appreciate the learning features associated with manipulating a 3D object has, to date, been limited in its use to situations where a student is involved in a self-directed study mode and is manipulating a 3D object that he/she has called up from a file stored on their local laptop.

While useful, needs remain in the provision of distance learning in terms of simulating the classroom environment, including “live” sessions including one or more teachers and a group of students.

### SUMMARY OF THE INVENTION

The needs remaining in the art are addressed by present invention, which relates to a teacher-controlled environment that allows for remotely-located students to participate in a live classroom session including the capability to view a teacher's 3D manipulation of objects associated with a lesson. That is, the present invention enables teacher-controlled viewing of 3D content (particularly relevant for STEM applications) across multiple student devices that are networked via a specific platform. The inventive configuration allows for remote manipulation of 3D objects (as controlled by the teacher), where the students wear stereoscopic 3D glasses and the teacher's remote software “takes over” the students'devices to enable the actual 3D object manipulation to appear on their devices.

An advantage of the present invention is the ability to provide real-time, live group sessions over a networked arrangement without experiencing signal transmission latency that would otherwise render the classroom simulation unworkable. The inclusion of a network-based learning platform (subscribed to by the teacher and the students) in combination of an appropriate educational software application installed on all devices (both teacher and students) results in needing only the teacher's command/control data signals (low bandwidth) to “take over” the operation of linked student devices. This is in contrast to some prior art models that require streaming of a high bandwidth video from the teacher to the students, where the high bandwidth requirement disrupts the real-time experience and likely also the quality of the video data as received by the students.

In an embodiment of the present invention, the teacher is able to pass control of a session to a designated student (“host”), where that student's device is then recognized as the “source” device and takes over the presentation on all remaining student devices (as well as the original teacher's device).

An exemplary embodiment may take the form of a networked instructional system utilizing 3D image capabilities for enhancing a learning experience, where the networked instructional system is based upon a learning platform implemented as a communication network element. The learning platform is configured to interact with a teacher computing device and a plurality of remotely-located student computing devices, wherein all computing devices have installed like educational software. The learning platform itself includes at least a service management component and a 3D imaging system. The service management component is used to control networked configurations of the teacher computing device and an identified subset of student computing devices for a real-time learning session. The 3D imaging system component utilizes associated objects within the installed educational software application and is responsive to all teacher lesson control commands for transmitting these commands to the plurality of remotely-located student computing devices such that the teacher computing device controls the operation of the student computing devices including the capability to remotely control projection and manipulation of 3D objects on the student computing devices.

Other and further embodiments and aspects of the present invention will become apparent during the course of the following discussion and by reference to the accompanying drawings.

### BRIEF DESCRIPTION OF THE DRAWINGS

Referring now to the drawings, where like numerals represent like elements in several view:

FIG. 1 is a diagram of an exemplary architecture of a network-based learning platform, used by a subscribed teacher and subscribed students to implement a virtual classroom experience that includes 3D instruction capabilities;

FIG. 2 depicts an exemplary configuration of a subscribed teacher and set of students, all using the same installed education software, particularly illustrating the replication of the teacher's display on the set of student devices; and

FIG. 3 contains a flowchart illustrating an exemplary process of setting up and using the inventive arrangement to implement a virtual classroom session.

### DETAILED DESCRIPTION

A significant improvement in on-line learning situations is provided in accordance with the principles of the present invention in the form of 3D instructional capabilities and particularly the capability of an instructor (“teacher”) to remotely control the presentation of 3D objects on students'computer displays. Opening up the third dimension for students via 3D technology, while allowing for the teacher to move an object in 3D space and have the students see the manipulations on their screens results in a solution that helps students learn more efficiently and develop a deeper understanding through teacher-guided instruction.

As will be discussed in detail below, the provision of a virtual classroom in accordance with the principles of the present invention is based upon the use of a network-connected learning platform in combination with an appropriate education-based software application that is installed on all devices (both teacher and students) and includes the capability to provide 3D objection projection.

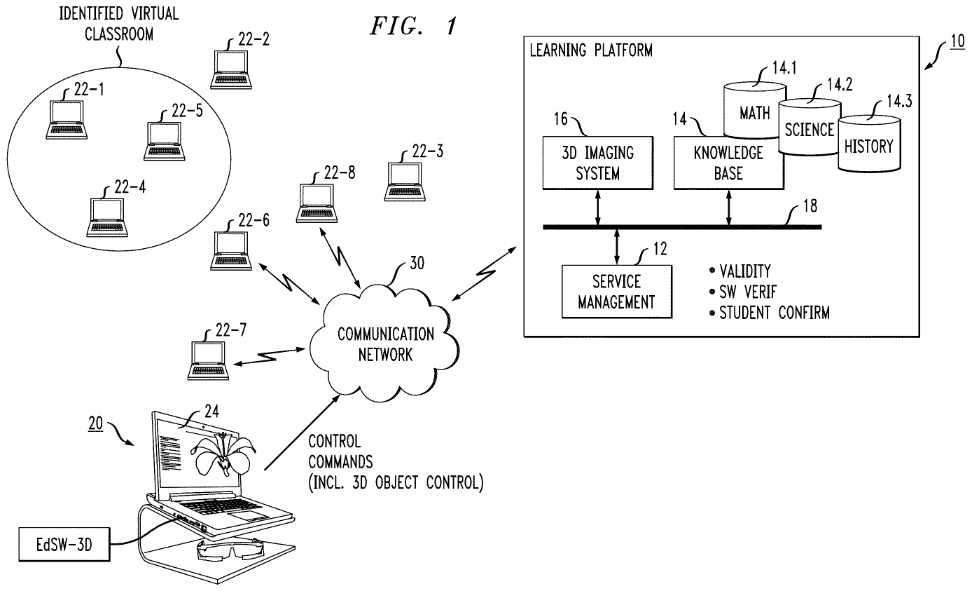

FIG. 1 is a diagram of an exemplary architecture where a learning platform 10 is used implement a virtual classroom experience that includes 3D instruction capabilities. In particular, learning platform 10 is utilized to enable a live classroom session between a teacher (using a teacher computing device 20) and one or more remote students (each using an individual student computing device 22), presenting the teacher's computer display 24 on the students'devices. As a result, 3D objects that are being manipulated by the teacher (via the installed educational software application) are similarly manipulated on student computing devices 22 without requiring any actions by the students. Said another way, the provision of a virtual live classroom including the manipulation of 3D objects is accomplished by allowing teacher computer device 20 to essentially “take over” student computing devices 22 and project the 3D object manipulation performed by the teacher to be replicated on the students'displays (students wearing stereoscopic glasses or similar devices, of course, to enable proper 3D viewing).

The exemplary embodiment of learning platform 10 as shown in FIG. 1 includes various components that interact with each other and the users (both teacher and students) in a manner that provides this live classroom capability, including the ability for teacher computing device 20 to take over student devices 22, including the capability to remotely project the 3D object manipulation being performed by the teacher. In this particular configuration, learning platform 10 comprises a service management module 12, a knowledge base 14, and a 3D imaging system 16, where these various components are shown in this exemplary embodiment as interacting with each other via a common communication bus 18. A communication network 30 is also shown in FIG. 1, and functions to provide communication links between teacher computing device 20 and the plurality of student devices 22 via learning platform 10.

With respect to learning platform 10, service management component 12 is primarily used for controlling access to learning platform 10, including not only general access in the first instance, but also managing various access levels and capabilities/functionalities available to different users. For example, service management component 12 may be used to control the various roles and permissions of a teacher and the students. In particular, prior to initiating a teaching session, service management component 12 polls all of the identified student devices connected to platform 10 to determine the version and/or subscription type of the teacher's and students'downloaded educational software (EdSW-3D). The identities of all devices are cross-referenced in order to verify the validity of executing the commands relevant to the educational software.

A similar type of authentication and permission process may be used by service management component 12 to control access to selected learning modules (e.g., 14.1, 14.2 and/or 14.3) within knowledge base 14. Some students may have access to only selected learning modules, or may only be able to implement and use certain 3D tools (the latter perhaps as a function of the type of device that the student is using and certainly the “version” of the educational software application as present on his/her device). Certain schools, learning centers, communities, or the like may have different levels of subscription, depending on the needs in their specific learning environments. While not shown in detail, it is contemplated that services management component 12 includes individual elements that perform user verification, record and store access history logs, monitor subscription records, and the like.

As mentioned above, 3D imaging system 16 is a foundational aspect of the present invention, providing the ability to add the third dimension to the presented material and giving the student a more “real world” setting within which to learn the material being presented. As discussed below, 3D imaging system 16 is particularly configured to allow a teacher to manipulate a 3D object during a “live” instructional session and have the same manipulations appear on the students'devices.

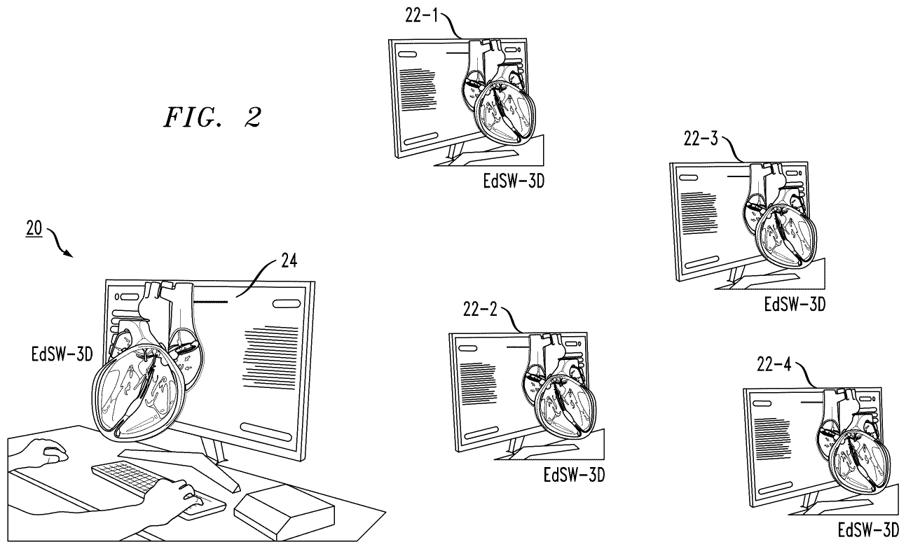

Another requirement of the system of the present invention is that teacher computing device 20 and the one or more student computing devices 22 all have the same version of an appropriate educational software package downloaded; without this, the various commands utilized by teacher computing device 20 to manipulate a 3D object may not be properly mirrored on student devices 22. This requirement is illustrated in FIG. 2 as an educational software application EdSW-3D which is installed on all computing devices 20 and 22. Also depicted in FIG. 2 is the replication of teacher display 24 on all of the student devices 22-1 through 22-4.

Returning to the description of FIG. 1, learning platform 10 enables the real-time provisioning of a virtual live classroom session between teacher computing device 20 and a teacher-selected set of student computing devices 22 (say, for example, devices 22-1, 22-4, and 22-5, as shown in FIG. 1) over a communication network 30. The operation of service management module 12 verifies the permissions and capabilities of both the teacher and identified students before setting up the live session between the identified devices. Once the learning session is initiated, teacher computer device 20 is able to take over the operation of student devices 22-1, 22-4, and 22-5, particularly in a manner where any 3D object manipulation performed by the teacher will be replicated on the student's devices 22-1, 22-4, and 22-5.

Thus, the present invention enables teacher-controlled viewing of 3D content (particularly relevant for STEM applications) across multiple student devices that are networked via platform 10, allowing for remote manipulation of 3D objects (as controlled by the teacher/host), where the student wears stereoscopic 3D glasses to view the 3D on his/her local device 22 and the teacher's remote software “takes over” the student's device to provide the actual 3D object movements.

A principle of the present invention is that a teacher is able to set up a live virtual classroom and control the 3D experience that each of the students receives through his/her computer. For this, both the teacher and the student must have the proper software loaded into their machines, as discussed above and shown in FIG. 2. The teacher is able to remotely set up some number of students as in a classroom setting, bring up the relevant teaching tools on his/her computer, and interact with them. Importantly, whatever the teacher sees and does on their monitor, the students see on their own computer in 3D as well (regardless of where the student is physically located—home, school, or any other location connected via a communication network).

Rather than simply sharing a video or screen from the teacher to the student (as possible in some prior art arrangements), the teacher-controlled remote 3D manipulation of the present invention is implemented by transmitting the commands used by the teacher across the network to the students'computers. Such commands may include, but are not limited to, specific interactions with the objects (manipulatives) present in the learning application. For example, the manipulation of 3D objects (e.g., zooming in, rotating, dragging across the screen, etc.) is recorded via commands that express the 3D location of the object on the screen relative to its default starting position. If the teacher clicks on a button within the object that highlights specific parts of the heart, the button click is logged as a command. Each command is immediately transmitted over the communication network to the students'devices and executed precisely in the linked 3D software applications running on the students'devices, resulting in the mirroring of the teacher's screen on the student's display. This communication path is shown by the arrows in FIG. 1.

Alternatively, any 3D manipulation of an object on the teacher's machine by using mouse movements or keystrokes need only to transmit the relatively “short” movement/keystroke commands over network 30 from the teacher to the students via the network connections provided by learning platform 10. Advantageously, by sending only these short, low bandwidth control commands, and not the entire video data load related to the 3D object itself, the bandwidth required for providing “remote” 3D object presentation is minimized.

Learning platform 10 (particularly, service management module 12) is enabled to accurately collect the command/control data from the teacher's interactions with objects present in the learning software, including not only the manipulation of various 3D objects, but various web pages accessed during a teaching session. In particular, every command performed on the teacher's computing device (i.e., pages visited, buttons clicked, cursor location, and the like) as well as 3D object manipulation commands are directed via network 30 to the group of students involved in the live teaching session. Importantly, inasmuch as the teacher is able to “take over” the students'devices and these devices are all operating on the same version of the installed software, the amount of data that needs to be transmitted from the teacher to the students is relatively low. Thus, problems with latency (which otherwise may be exhibited when transmitting command data to various remote terminals at disparate distances from the teacher's computer) are avoided by minimizing the volume of actual data that is needed to control the students'devices.

Said another way, by virtue of utilizing learning platform 10 to control communications across the network between the teacher and the remote students, only succinct, low bandwidth control commands need to be transmitted in order for the teacher's various computer-based actions (including 3D object manipulation) to be mirrored on the students'devices. With minimal latency, the commands are transmitted essentially immediately to all students, thus providing a learning situation that best simulates the in-person classroom experience.

As an example, a teacher decides to talk about blood circulation and shows a 3D “heart” scene as part of the lesson. If the presentation were restricted by the limitations of the prior art (e.g., over a platform such as Zoom), the teacher's screen would be “shared”, but the students would not be able to “see” the object in three dimensions. In accordance with the present invention, inasmuch as each student's computer already has access to the various 3D models that may be used, only the teacher's commands need to be transmitted. The actual 3D manipulation is created locally on the student's machine, as controlled by the commands received over the communication link from the teacher's computer system.

FIG. 2 illustrates this capability in an example where a teacher is describing the operation of a heart with reference to a 3D rendering of the heart. His/her movements and keyboard strokes are remotely and simultaneously shared across selected students'monitors who are also logged into the platform of the inventive system, allowing for the lesson to be conveyed “live” and permitting the students to have the full 3D image movement.

As part of the live interaction, group dynamics can also be made flexible where, for example, control may be passed from a teacher to a student at various points in the lesson. Multiple teachers and student teams may also be accommodated in a session. Indeed, preferred embodiments of the present invention further enable the teacher to pass “control” of the lesson to a designated student (then identified as the “host”), enabling the student's device 22H to operate in a manner similar to teacher computer device 20. Thereafter, the designated student device becomes the “teacher” (at least temporarily), taking over what is presented on the other devices in the learning session (including teacher computing device 20). In all cases, the default “teacher” computing device 20 retains overall control of enabling others to lead, and can return control to his/her device at any time.

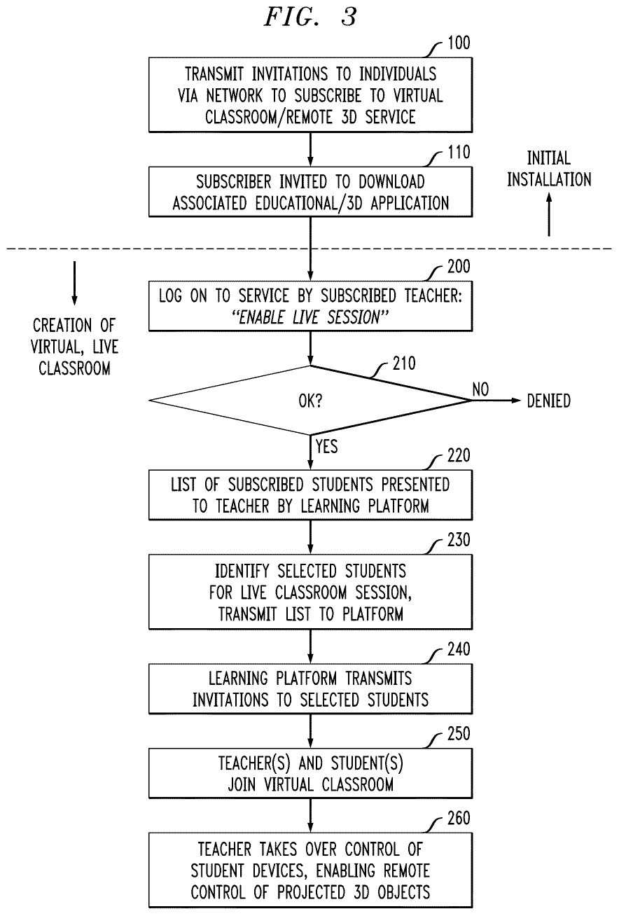

FIG. 3 contains a flowchart illustrating an exemplary process as utilized in accordance with the present invention to provision a virtual, live classroom session including a teacher's ability to remotely control the projection and manipulation of 3D objects on the students'displays. In an initial step (shown as step 100 in FIG. 3), various individuals are invited to subscribe to a learning platform that supports the configuration of virtual live classroom sessions including 3D object manipulation in accordance with the principles of the present invention. The subscriptions may vary as a function of defined roles (i.e., teacher or student) and/or particular content/subject matter areas (e.g., Pre-K through grade 6, high school, college, STEM, history, art, etc.). Service management module 12 is used in most cases to monitor the subscriptions and control the access of teachers and students to only those elements associated with a particular subscription.

Once a subscription is approved, the individual subscriber is invited to download the educational software application (referred to above at times as EdSW-3D) and install it on his/her local device. This is shown as step 110 in FIG. 3, and is considered as the final step in the initial set-up process.

Thereafter, a subscribed teacher may log on to the service (step 200) and initialize a virtual classroom session (for example, by clicking on a button/hot link for “enable live session”). This command is transmitted via network 30 to learning platform 10, where service management module first validates the teacher's subscription ID (step 210) and, if valid, presents a list of pre-subscribed students associated with that teacher (step 220). The teacher responds by identifying the particular students to include in the instantiated classroom (step 230), and learning platform 10 thereafter transmits “invitations” to the selected students (step 240). In response, the selected students join the teacher in the virtual classroom (step 250) and thereafter the teacher begins the teaching session, which may include the activation of a particular learning module 14.x (available from learning platform 10) which is accessible by all of the students. At some point in the instruction, the teacher utilizes his/her computing device 20 to present a 3D object and control its movements. In accordance with the principles of the present invention, by transmitting the teacher's controls as commands recognized by the educational software application on the students'devices in the manner described above (step 260), the teacher is able to remotely control the projection and movement of 3D objects on the students'devices.

In some cases, the process as outlined above may include one or more steps to verify that all of the selected students have downloaded the same version of the educational software application that is being used by the teacher. Further verifications may also be performed to ensure that the identified students have subscribed access to certain grade levels and/or subject matter categories.

Summarizing, the present invention provides the concurrent sharing of control commands (in the form of a teacher's (host's) mouse movements, keyboard strokes, and/or specific interactions with objects present in the 3D learning software application) with a group of students that may be located in proximity to the teacher or at a remote location. In any case, the students and teacher need to have the same 3D capabilities within their computers such that the commands transmitted by the teacher to the students provides the desired manipulation of the selected 3D object as appearing on the student's computer.

While the present invention has been discussed in connection with preferred embodiments, it will be understood that various modifications will be readily apparent to those skilled in the art. Thus, the present disclosure is intended to be exemplary only, with the scope of the present invention covering any adaptations or variations thereof. For example, different labels for the various features, screen sections, and database organizations may be used without departing from the scope of the invention. Indeed, this invention should be limited only by the claims appended hereto, and equivalents thereof.

What is claimed is:

1. A networked instructional system utilizing 3D image capabilities for enhancing a learning experience, the networked instructional system comprising
a learning platform implemented as a communication network element for interacting with a teacher computing device and a plurality of remotely-located student computing devices, wherein all computing devices have installed like educational software, the learning platform including
a service management component for controlling networked configurations of the teacher computing device and an identified subset of student computing devices for a real-time learning session; and
a 3D imaging system component compatible with controlling manipulation of objects within the educational software application, the 3D imaging system responsive to teacher lesson control commands and thereafter transmitting these commands to the plurality of remotely-located student computing devices such that the teacher computing device controls the operation of the student computing devices including the capability to remotely control projection and manipulation of 3D objects on the student computing devices.

2. The networked instructional system as defined in claim 1 wherein the teacher lesson control commands associated with 3D object manipulation include at least keystrokes delivered by the teacher computing device.

3. The networked instructional system as defined in claim 1 wherein the teacher lesson control commands associated with 3D objection manipulation include movements of a mouse controller associated with the teacher computing device.

4. The networked instructional system as defined in claim 1 wherein the service management component is configured to verify the existence of a same version of the educational software on the teacher computing device and the identified subset of student computing devices prior to initiating a virtual classroom session.

5. The networked instructional system as defined in claim 1 wherein the service management component is configured to transfer control of an instantiated classroom session from the teacher computing device to an identified student computing device upon receipt of a “transfer of control” command from the teacher computing device.

6. The networked instructional system as defined in claim 5 wherein the transfer of control to a student computing device includes the capability of the identified student computing device to perform 3D object manipulation that is replicated on the remaining student computing devices and the teacher computing device.
